(19) United States
(12) Patent Application Publication
(10) Pub. No.: US 2006/0022632 A1
(43) Pub. Date: Feb. 2, 2006

(54) Air drive electric charging

(76) Inventor: Constantinos Tsatsis, Lynnfield, MA (US)

Correspondence Address: GEORGE E. KERSEY, P.O. Box 836, Lynnfield, MA, 01940, US

(21) Appl. No.: 10/902,111

(22) Filed: Jul. 30, 2004

(51) Int. Cl. H02J 7/00

(52) U.S. Cl. 320/104

(57) ABSTRACT

Method and apparatus for electrical storage and auxiliary air assisted turbine charging, by having the turbine driven by pressure, supplemented by auxiliary air action, to operate a generator that produces electrical energy that is stored, for example in a battery to operate a motor vehicle; when the stored charge falls below a prescribed level the turbine is operated until the prescribed level stored charge is reached. The electrical storage thus produced may be used as an emergency source of electricity, for example, to provide power when a source, such as a public utility, in interrupted in an emergency.

### BACKGROUND OF THE INVENTION

This invention relates to electric charging and, more particularly, to the air-powered charging of electric storage devices, such as batteries, to supply energy at a prescribed level over a prolonged period for operating a vehicle or providing an emergency source of power, for example, for household use when public mains are interrupted.

The typical electric storage battery installed in a vehicle is used only for starting and lighting because the electrical energy stored in the battery is insufficient to operate the vehicle. Once the vehicle is started the further operation usually is by an internal combustion engine, which is a significant source of air pollution. Attempts have been made to power vehicles from alternative sources, but these have many drawbacks. Solar panels require such a large charging surface that they are presently unsuitable. Electric vehicles that use the ordinary recharge systems have a limited range of operation and require frequent returns to electric charging stations.

For conventional electric vehicles, the travel range is about 100 miles, limiting their use to local urban travel. In order to obtain even this range, it is necessary to have a relatively large on-board battery and associated electrical drive motors. When the battery becomes discharged, it is necessary to stop for a recharge the battery, which not only requires an appropriate charging facility but also sufficient time for the recharge to take place.

While additional storage batteries could extend the range, this is undesirable because such batteries are heavy, bulky and require additional space. In addition, the added weight could reduce mileage efficiency, and additional time would be needed to recharge the additional batteries.

An alternative solution would be to store energy in a form that does not require the excessive weight of additional storage batteries. This can allow the range of vehicle operation to be extended without the need for frequent recharging and also would avoid the reduction in mileage efficiency associated with the weight of additional batteries.

In my prior invention of Application No. 120478, filed Jul. 23, 1998, I used a tank of high-pressure air to store sufficient energy that can provide for battery recharge by way of a turbine and an electrical generator. The recharge is activated as the battery becomes discharged in order to keep the battery fully charged. Other auxiliary equipment can extend a vehicle's range further after initial battery charge and compressed air energy are exhausted. This involves the use of a small gasoline motor to keep the battery charged and the air tank pressurized. The gasoline motor can recharge the battery by driving the air compressor to re-pressurize the air tank and thus extend the range of the vehicle to what is limited by the amount of stored fuel. This extends the capability of electric powered vehicles without seeking to provide more efficient batteries.

Accordingly, it is an object of the invention to increase further the capability of an electric powered vehicle without seeking to provide more efficient batteries.

A related object of the invention is to produce greater still efficiency in automotive propulsion. Another object of the invention is to limit the atmospheric pollutants associated with automotive propulsion.

A still further object of the invention is to limit the extent to which other auxiliary equipment is needed to extend a vehicle's range further after initial battery charge and compressed air energy are exhausted. A related object is top avoid the need for using a small gasoline motor to keep the battery charged and the air tank pressurized

Accordingly, it is a further object of the invention to overcome the problems of the prior art.

### SUMMARY OF THE INVENTION

In accordance with the invention, enhanced automotive propulsion can be accomplished by apparatus for storing electrical energy; a mechanism for charging the electrical storage apparatus; and operating the charging mechanism selectively by auxiliary air flow.

The electrical storage can be in a battery for providing an alternative source of electric power, including emergency power for household operation in the event of an interruption in public utility power.

Such a battery can be installed to supply motive power for a vehicle, including automobiles, and the auxiliary air flow can be through an air duct in the vehicle.

In accordance with one aspect of the invention, the air duct permits air to flow thereinto from the exterior of the vehicle to the interior thereof, and the air of the air duct is used for driving a turbine.

When the charges on the electrical storage device are monitored, the charging mechanism is operated when charge on the electrical storage device falls below a prescribed level and the charging mechanism is connected to a transmission. Operation of the charging mechanism can be terminated when charge on said electrical storage device returns to its prescribed level.

In a method of the invention for electrical charging the steps include storing electrical energy in electrical storage means; and charging the electrical storage means by auxiliary air flow from a venturi. The method also includes storing electrical energy in a battery charged by a generator driven from a turbine through a transmission.

In accordance with one aspect of the method, the battery can be installed in a vehicle to supply motive power therefore and charging the battery by use of compressed fluid supplemented by auxiliary air flow, which can be supplied to a turbine through a plurality of venturis.

The auxiliary air flow can be supplied by wind resistance to the vehicl, either at rest or while in operation. The means for generating electrical charges can comprise a pressure storage tank connected to a turbine which is operable by auxiliary air flow. The charge on the electrical storage means can be monitored to operate the means for generating electrical charges when the charge on the electrical storage means falls below a prescribed level. The operation of the means for generating electrical energy is terminated when charge on the electrical storage means returns to a prescribed level.

In accordance with a method of the invention for fabricating electrical charging apparatus, the steps include: (a) providing means for storing electrical energy; and (b) providing means for supplementing the charging the electrical storage means by auxiliary air flow. The electrical storage means can comprise a battery for a vehicle, charged by means for storing a compressed gaseous fluid which can operate a turbine in conjunction with auxiliary air flow.

In the method ducts can be installed in a vehicle to provide for auxiliary air flow.

### DESCRIPTION OF THE DRAWINGS

Other aspects of the invention will become apparent after considering several illustrative embodiments taken in conjunction with the drawings in which:

FIG. 1 is a diagram of an automobile provided with ducts for an air-assisted electric charging system in accordance with the invention;

FIG. 2 is a schematic diagram showing the invention adapted for use in an electric vehicle;

FIG. 3 is a schematic diagram of a further alternative embodiment of the invention.

### DETAILED DESCRIPTION

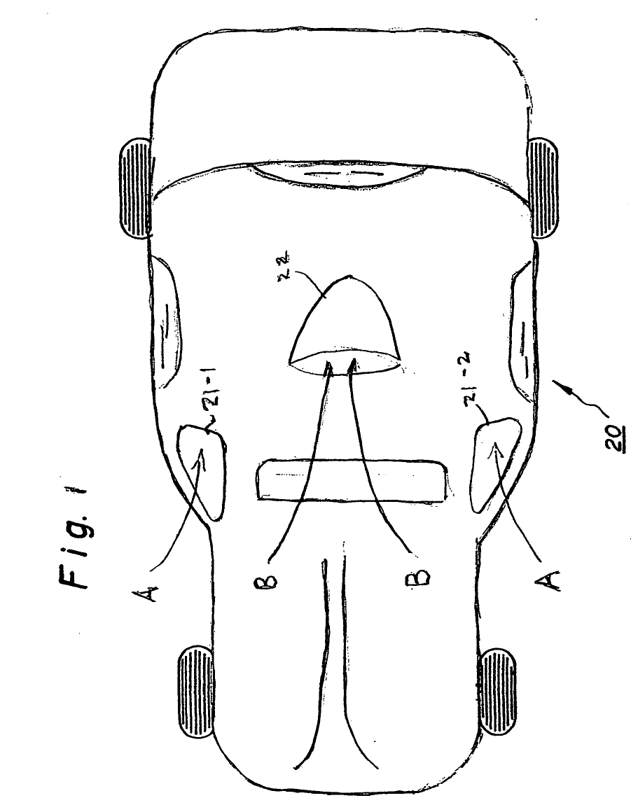

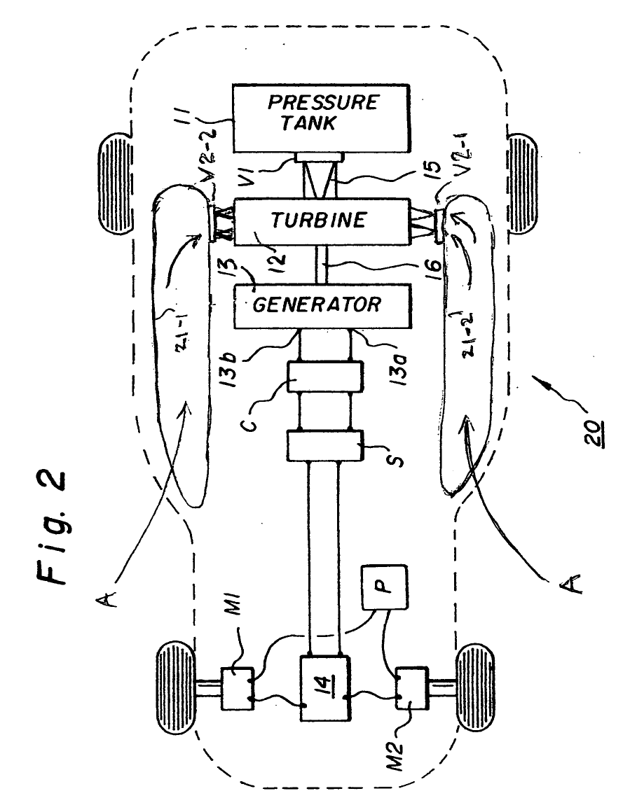

With reference to the drawings, the diagram of FIG. 1 shows an automobile 20 equipped with ducts for air-assisted electric charging. Ducts 21-1 and 21-2 are located on the left and right sides of the vehicle 20 and lead into the interior underside of the vehicle 20 as shown in FIG. 2 A third duct 22 is at the top center of the vehicle 20 and acts as a scoop that can be rotated to take advantage of the direction from which the air flow, for example from wind, is the strongest. The ducts 21-1 and 21-2 receive air flow as i9ndicated by the arros A, whicle the scoop 22 receives air flow indicated by the arrow B.

The block diagram of FIG. 2 outlines the primary components of a pressurized electric charging system 10 of the invention, which includes a pressure tank 11, a turbine 12, a generator 13 that can be driven by an auxiliary motor 17, and an array 14 of batteries. Interconnecting the pressure tank 11 and the turbine 12 is a venturi nozzle 15 which can raise the pressure that is released from the tank 11 at an appropriate time interval as explained below. The turbine 12 is connected to the generator 13 through a transmission 13t in order to operate the generator 13 at an appropriate voltage output level. The generator 13 supplies its out directly to limiter L to provide a charging voltage of appropriate level to the battery bank 14. While a common battery voltage is 12 volts, lower and higher voltages can be used as well.

To supply air assistance to the turbine 12, the duct 21-1 is connected to the turbine 12 by a dual venturi V2-2. Similarly, the duct 21-2 is connected to the turbine 12 by a dual venturi V2-1

In addition, line 13c and 13d permit the output of the generator 13 to be used as an emergency supply. Thus when the mains to household are interrupted, for example during a hurricane or other emergency, the lines 13c and 13d can be connected to the household after disconnecting the lines to the mains.

When pressure P1 from the tank 11 is released through the venturi 15, and there is auxiliary air flow through the venturis V2-1 and V2-2, air enters the turbine 12, the rotation of the turbine 12, because of the gas pressure P2 on its interior blades (not visible in FIG. 1), causes the rotation of the generator 13 by virtue of the coupling 16 of the respective shafts of the turbine 12 and the generator 13 through the transmission 13t which controls the rotation of the generator in relation to the turbine 12 in order to produce the desired voltage level at the output terminals 13a and 13b.

To assist the rotation of the turbine 12 from the pressure tank 11, a clutch 17c is included between the induction motor 17 and turbine 12. The clutch 17c assures synchronization between the rotation of the turbine because of pressure from the tank 11 and the rotation of the induction motor 17. The field windings of the motor 17 can be energized from the output of the generator 13 through a switch W1, or from the battery bank 14 through a switch W2.

The pressure tank 11 can be charged either externally, when the system of FIG. 1 is installed in a unit, such as an automobile as shown in FIG. 2, or internally by the compressor system 18, which can take any number of known forms. The compressor system 18 can be a standard gasoline engine compressor using an ordinary internal combustion engine. However to avoid atmospheric pollution from an internal combustion engine, a fuel cell may be employed to operated an electrically driven compressor. Such a fuel cell, as is well known applies a substance, such as hydrogen, to one electrode, and oxygen to another electrode to permit electrical charges to flow between the electrodes. Where hydrogen, for example in tank form, is not available, any other well known substitute may be employed, as has been the case with the fuel cells employed by NASA, the National Space Administration. Suitable substitutes for hydrogen include methyl alcohol, hydrazine, or a simple hydrocarbon.

It will be understood that the turbine 12, the generator 13, the battery bank 14 and the induction motor 17 are each of conventional construction. In addition the transmission 13t and the clutch 17c are of conventional construction.

In FIG. 2, the voltage produced by the generator 13 is applied to the bank 14 of batteries 14a-14n. Accordingly, the generator 13 produces a Direct Current (DC) output. For that purpose the generator 13 may have a conventional magnetized rotor and a conventional stator winding which can supply additional magnetization to the rotor windings. The output is taken from the stator in conventional fashion. Similarly the induction motor 17 may have a magnetic stator or rotor with electrical energy to supply rotation applied to the rotor or stator.

It will be understood that other types of DC generator may be employed and that the generator 13 can produce Alternating Current (AC), as well as other forms of output, particularly when the system 10 of FIG. 1 is used as an emergency power source, for example to supply a household when emergency power is the only power available.

Accordingly, when pressure is released from the tank 11, for example through the venturi 15, by opening the control valve V1, the turbine 12 begins to rotate and a voltage appears across the terminals 13a and 13b. In order to facilitate the operation of the turbine 12, its operation can be joined by that of the induction motor 17, through the clutch 17c when the rotations are appropriate. It is convenient to use this generated voltage to charge the batteries of the bank 14, made up of individual parallel cells 14a-14n. In order to prevent the batteries from being overcharged, the lead 13a and 13b are connected to a voltage limiter L.

For the conventional lead-acid battery in common use, normal voltage is 6 or 12 Direct Current volts. The charging voltage normally exceeds the nominal battery voltage, so that the generator 13 is limited to a voltage on the order of 7 or 14 volts, respectively.

When the battery array 14 is fully charged, the venturi outlet valve V1 is closed so that the charging voltage from the generator 13 is removed from the storage battery array 14. Once the batteries of the array 14 are fully charged, they can be used to supply direct current energy in conventional fashion.

One adaptation of the invention is illustrated in FIG. 2 where the system 10 of FIG. 1 is used in a vehicle 20, shown in dashed outline. The battery bank 14 of FIG. 1 becomes the storage battery assemblage 14 of the vehicle 20, and is used to supply Direct Current to motors M1 and M2 through a control panel P. The motors M1 and M2 provide front-wheel drive through respective axles connected to the front tires of the vehicle 20. The turbine 12 and generator 13 take the place of a conventional engine. The turbine can be motorized by the motor 17 by operating one of the switches W1 or W2.

Instead of having a fuel tank, or a bank of solar cells, the vehicle 20 includes the pressure tank 11 and the motorizable turbine 12 of the invention.

It is readily apparent that when the system 10 of the invention is used in a device, such as the vehicle 20, it provides definite advantages over other electrical systems, such as those provided by batteries required to be charged at an external charging source. In the case of the invention, the vehicle 20 carries with it a pressure tank source 11 for recharging its battery assemblage 14.

Thus, when the voltage level of the battery assemblage 14 in the vehicle 20 drops below a prescribed level, the energy stored in the pressure tank 11 can be used to bring the voltage of the battery assemblage 14 back to a desired level. Consequently, a driver does not need to be concerned when the voltage of his battery assemblage 14 falls to a level which, in the case of a conventional electric vehicle, requires a return to an external charging station. In the case of the invention, all that is needed is to release the pressure stored in the pressure storage tank 11 to operate the turbine 12 and the generator 13 to provide a suitable level of charge on the battery assemblage 14.

The recharging can be accomplished manually, or automatically. For manual operation a sensor in the control panel P monitors the battery assemblage voltage and indicates when recharging is needed. The operator can then open the valve V1 until the desired level of charge is attained. Operation of the valve V1 can be by solenoid action.

For automatic operation standard sensors, e.g. sensor S, are employed with the valve V1 and a comparator C which compares the voltage of the generator 13 with the voltage of the battery bank 14. When the comparator C senses that the battery voltage is less than needed, it opens the valve V1.

The turbine 12 is used in conjunction with the generator 13 to produce electrical power. Fluid power for the turbine 12 can be provided by a compressor system during those periods when the output generator level falls below a prescribed value.

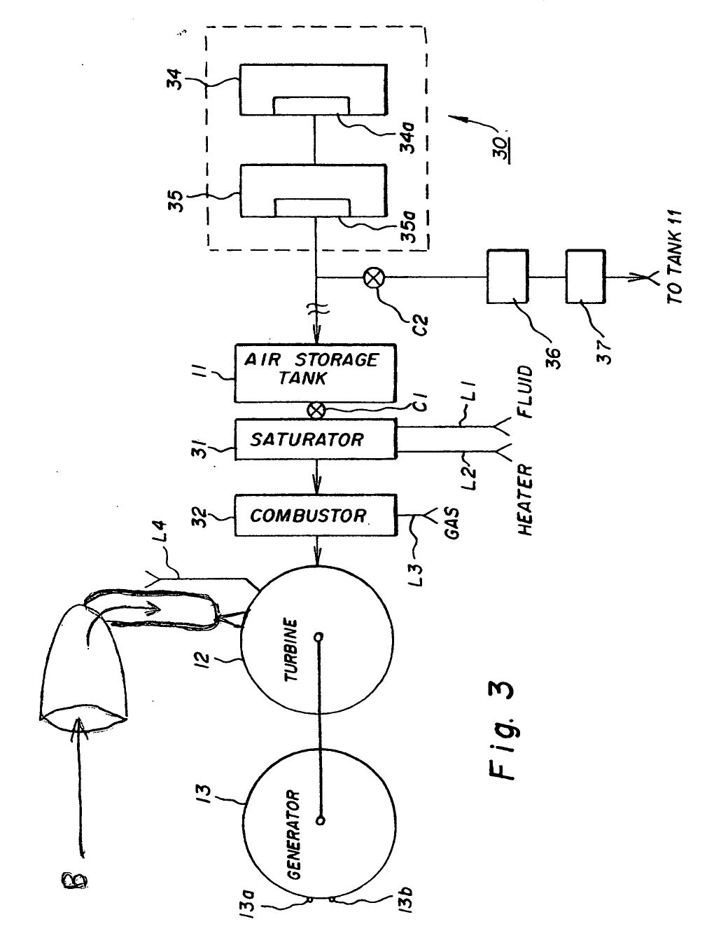

As indicated in FIG. 3, a separate compressor system 30 can be used to store fluid, such as air, in the pressure storage tank or chamber 11. The compressed fluid from the tank 11 is used during those intervals when the battery level is to be returned to its desired value. When the tank 11 is being pressurized, it can be disconnected from the turbine by operation of a control valve C1.

To pressurize the tank 11, the compressor system 30 includes a low-pressure compressor 34 and a high-pressure compressor 35. Preferably the low pressure compressor 34 is coupled to an inter-cooler 34a to remove some of the thermal energy of compression. The continuous output of the high-pressure compressor 35 is preferably coupled to an after-cooler 35a which removes additional thermal energy from the resultant continuously compressed air stream.

The thermal energy thus removed can be applied to a saturator. The resultant compressed air can flow directly to the tank 11, or, after opening of a control valve C2, can flow continuously and directly from the compressor system to a saturator 36 before being applied to a combustor 37. The saturator 36 is more effective if used in conjunction with an after-cooler, which does not remove excessive thermal energy from the compressed air stream that exits the compressor system 30.

The compressed air stream produced by the compressor system 30 contains both mechanical and thermal energy. When processed through an after-cooler, much of the thermal energy is withdrawn. This is required so that the compressed air will be cold enough to be compatible with a practical air storage tank. The air stream thus cooled is conveyed to the tank 11 to store the mechanical energy of the compressed air.

This mechanically stored energy is used when the compressor system 30 is shut down and a voltage level, such as that of the battery bank 14, is insufficient. This energy may be used in conjunction with fuel fed to the turbine through the combustor by line L3, or directly by line L4. More specifically, compressed air from the storage tank 11 can be conveyed to a combuster, such as the combustor 32, through an appropriate configuration of valves.

To enhance the efficiency of the system, a saturator 31 can be positioned between the storage tank 111 and a combustor 32, which can provide hot gas for driving the turbine 12. The saturator 31 receives compressed air from the storage tank 11 and simultaneously heats and humidifies it. Fluid for humidification can be supplied over line L1, and heater current can be applied over line L2, from, for example, the battery assemblage 14 of FIG. 1, or other source. The resulting heated and humidified compressed air is conveyed to the combuster 32.

Power production by the turbine 12 is enhanced by the combination of air storage and saturation, i.e. humidification and post-storage heating. This combination yields a number of advantages. It enables the continuous operation of a battery system, such as the assemblage 14 of FIGS. 1 and 2.

By conveying a pressurized air steam from the storage tank 11 to the saturator 31, the turbine 12 can receive a heated and humidified gaseous stream with greater mass flow and greater thermal energy. This provides the saturator with a reduced amount of needed energy and thus a reduction in any required fuel. Consequently, the invention can reduce undesirable emissions.

A specific embodiment of an enhanced system in accordance with the invention contains a combination of air storage, fuel processing and “saturation” by simultaneous heating and humidification of air.

A motor (not shown) drives the compressor system 30. The thermal energy of the compressed air stream is removed by heating water in an inter-cooler and after-cooler, and the heated water can be conveyed to a hot water storage tank.

Cooling may also be provided to reduce some of the water temperature in the inter-cooler and in the after-cooler. Some of the compressed air stream produced by the system 30 can be conveyed directly through an open valve to the tank 11, while the remainder can go directly to the saturator 36 through an open valve C2.

The system is preferably sized to compress more air while “on” than is consumed by the turbine 12. Overtime, the air storage and withdrawal can remain in balance. Thus, the air storage tank 11 serves to conserve the mechanical energy of compressed air, and the thermal energy not removed by an aftercooler. A hot water tank can store much of the energy of compression. These sources of energy may be used in accordance with the invention with the mechanical energy used at time periods when it is necessary to recharge the battery bank 14.

While preferred embodiments have been shown and described, it is to be understood that changes in details of construction and method from what has been illustrated may be made without departing from the spirit and scope of the invention as defined by the foregoing appended claims.

What is claimed:

1. Apparatus comprising
means for storing electrical energy; and
means for charging the electrical storage means; and
means for operating the charging means by auxiliary air flow.

2. Apparatus as defined in claim 1 wherein said electrical storage means comprises a battery for providing an alternative source of electric power, including emergency power for household operation in the event of an interruption in public utility power.

3. Apparatus as defined in claim 2 wherein said battery is installed to supply motive power for a vehicle, including automobiles.

4. Apparatus as defined in claim 3 wherein said auxiliary air flow is through an air duct in said vehicle.

5. Apparatus as defined in claim 4 wherein said air duct permits air to flow thereinto from the exterior of said vehicle to the interior thereof.

6. Apparatus as defined in claim 5 wherein said air of said air duct is used for driving a turbine.

7. Apparatus as defined in claim 6 wherein the charges on said electrical storage means are monitored and said charging means is operated when said charge on said electrical storage means falls below a prescribed level and said charging means is connected to a transmission.

8. Apparatus as defined in claim 7 wherein the operation of said charging means is terminated when said charge on said electrical storage means returns to said prescribed level.

9. A method of electrical charging comprising
storing electrical energy in electrical storage means; and
charging said electrical storage means by auxiliary air flow from a venturi.

10. The method of claim 9 including storing electrical energy in a battery charged by a generator driven from a turbine through a transmission.

11. The method of claim 10 including installing said battery in a vehicle to supply motive power therefore and charging said battery by use of compressed fluid supplemented by said auxiliary air flow.

12. The method of claim 9 wherein said auxiliary air flow is supplied to a turbine through a plurality of venturis.

13. The method of claim 12 wherein said auxiliary air flow is supplied by wind resistance to said vehicle.

14. The method of claim 13 wherein said wind resistance is supplied when said vehicle is operated.

15. The method of claim 14 wherein said means for generating electrical charges comprises a pressure storage tank connected to a turbine which is operable by said auxiliary air flow.

16. The method of claim 15 wherein the charge on said electrical storage means is monitored and said means for generating electrical charges is operated when said charge on said electrical storage means falls below a prescribed level.

17. The method of claim 16 wherein the operation of said means for generating electrical energy is terminated when said charge on said electrical storage means returns to said prescribed level.

18. A method of fabricating electrical charging apparatus comprising the steps of:
(a) providing means for storing electrical energy; and
(b) providing means for supplementing the charging the electrical storage means by auxiliary air flow.

19. The method of claim 18 wherein said electrical storage means comprises a battery for a vehicle, charge for said battery is provided by means for storing a compressed gaseous fluid which can operate a turbine in conjunction with said auxiliary air flow.

20. The method of claim 19 wherein ducts are installed in said vehicle to provide for said auxiliary air flow.
